(19) United States
(12) Patent Application Publication
(10) Pub. No.: US 2022/0317416 A1
(43) Pub. Date: Oct. 6, 2022

(54) Optical Imaging Lens Assembly

(71) Applicant: ZHEJIANG SUNNY OPTICS CO., LTD., Ningbo, Zhejiang (CN)

(72) Inventors: Yi ZHANG, Ningbo, Zhejiang (CN); Kaiyuan ZHANG, Ningbo, Zhejiang (CN); Fujian DAI, Ningbo, Zhejiang (CN); Liefeng ZHAO, Ningbo, Zhejiang (CN)

(21) Appl. No.: 17/641,453

(22) PCT Filed: Jul. 24, 2020
(86) PCT No.: PCT/CN2020/104461

§ 371 Date: Mar. 9, 2022

(30) Foreign Application Priority Data
Sep. 12, 2019 (CN) 2019 10866380.X

(51) Int. Cl. G02B 9/58; G02B 13/00; G02B 9/34

(52) U.S. Cl. CPC G02B 9/58; G02B 13/004; G02B 9/34

(57) ABSTRACT

The disclosure provides an optical imaging lens assembly, sequentially including from an object side to an image side along an optical axis: a first lens with a refractive power; a second lens with a refractive power; a third lens with a positive refractive power; and a fourth lens with a negative refractive power, wherein an object-side surface thereof is a convex surface. A total effective focal length f of the optical imaging lens assembly meets: 20 mm<f<30 mm.

### CROSS-REFERENCE TO RELATED PRESENT INVENTION(S)

The disclosure claims priority to and the benefit of Chinese Patent Disclosure No.201910866380.X, filed in the China National Intellectual Property Administration (CNIPA) on 12 Sep. 2019, which is incorporated herein by reference in its entirety.

### TECHNICAL FIELD

The disclosure relates to the technical field of optical elements, and more particularly, to an optical imaging lens assembly.

### BACKGROUND

With the popularization of portable electronic products such as mobile phones and tablet computers, requirements of users on the imaging quality thereof have also increased. Meanwhile, a currently emerging dual-camera technology usually needs a telephoto lens to achieve a relatively high spatial angular resolution.

In order to satisfy market development requirements, it is necessary to use as few elements as possible to shorten the total length of the imaging lens. However, reduces the degree of design freedom and makes it difficult to satisfy a requirement on the imaging quality.

### SUMMARY

An embodiment of the disclosure provides an optical imaging lens assembly, which sequentially includes from an object side to an image side along an optical axis: a first lens; a second lens; a third lens with a positive refractive power; and a fourth lens with a negative refractive power, wherein an object-side surface thereof is a convex surface.

In an implementation mode, a total effective focal length f of the optical imaging lens assembly meets: 20 mm<f<30 mm.

In an implementation mode, a curvature radius R7 of the object-side surface of the fourth lens, a curvature radius R8 of an image-side surface of the fourth lens, and an effective focal length f4 of the fourth lens meet: −1.7<(R7−R8)/f4<0.

In an implementation mode, FOV is a maximum field of view of the optical imaging lens assembly meets: 10°<FOV<15°.

In an implementation mode, an effective focal length f3 of the third lens, an effective radius DT31 of an object-side surface of the third lens, and an effective radius DT32 of an image-side surface of the third lens meet: 1.2<f3/(DT31+DT32)<2.3.

In an implementation mode, an effective radius DT11 of an object-side surface of the first lens and an effective radius DT41 of the object-side surface of the fourth lens meet: 0.8<DT11/DT41<1.2.

In an implementation mode, a refractive index N1 of the first lens, a refractive index N2 of the second lens, a refractive index N3 of the third lens, and a refractive index N4 of the fourth lens meet: 1.8<(N1+N2+N3+N4)/4<2.0.

In an implementation mode, the optical imaging lens assembly further includes a diaphragm, TTL is a distance from an object-side surface of the first lens to an imaging surface of the optical imaging lens assembly on the optical axis, and SL is a distance from the diaphragm to the imaging surface on the optical axis, a center thickness CT1 of the first lens on the optical axis, a center thickness CT2 of the second lens on the optical axis, TTL and SL meet: 0.1<(CT1+CT2)/(TTL−SL)<0.9.

In an implementation mode, BFL is a distance from an image-side surface of the fourth lens to the imaging surface on the optical axis BFL and the total effective focal length f of the optical imaging lens assembly meet: 0.7<BFL/f<1.2.

In an implementation mode, SAG41 is a distance on the optical axis from an intersection point of the object-side surface of the fourth lens and the optical axis to an effective radius vertex of the object-side surface of the fourth lens, SAG42 is a distance on the optical axis from an intersection point of the image-side surface of the fourth lens and the optical axis to an effective radius vertex of the image-side surface of the fourth lens, and ImgH is a half of a diagonal length of an effective pixel region on the imaging surface of the optical imaging lens assembly, SAG41 and SAG42 and ImgH meet: 0.4<(SAG41+SAG42)/ImgH<1.6.

In an implementation mode, SAG11 is a distance on the optical axis from an intersection point of an object-side surface of the first lens and the optical axis to an effective radius vertex of the object-side surface of the first lens, and T12 is a spacing distance between the first lens and the second lens on the optical axis, the center thickness CT1 of the first lens on the optical axis, a center thickness CT1 of the first lens on the optical axis and SAG11 and T12 meet: 0.1<|SAG11|/(CT1+T12)<0.8.

In an implementation mode, at least three lenses of the first lens to the fourth lens may be made of a glass material.

In an implementation mode, an object-side surface and an image-side surface of at least one of the first lens to the fourth lens may be spherical surfaces.

According to the disclosure, four lenses are adopted, and the refractive powers and surface types of each lens, the center thicknesses of each lens, on-axis spacing distances between the lenses and the like are configured reasonably to achieve at least one of beneficial effects of excessively large focal length, high resolution, high imaging quality and the like of the optical imaging lens assembly.

### BRIEF DESCRIPTION OF THE DRAWINGS

The other features, objectives and advantages of the disclosure become more apparent upon reading detailed descriptions made to unrestrictive embodiment s with reference to the following drawings.

FIG. 1 shows a structure diagram of an optical imaging lens assembly according to Embodiment 1 of the disclosure;

FIGS. 2A to 2C show a longitudinal aberration curve, an astigmatic curve, and a distortion curve of the optical imaging lens assembly according to Embodiment 1 respectively;

FIG. 3 shows a structure diagram of an optical imaging lens assembly according to Embodiment 2 of the disclosure;

FIGS. 4A to 4C show a longitudinal aberration curve, an astigmatic curve, and a distortion curve of the optical imaging lens assembly according to Embodiment 2 respectively;

FIG. 5 shows a structure diagram of an optical imaging lens assembly according to Embodiment 3 of the disclosure;

FIGS. 6A to 6C show a longitudinal aberration curve, an astigmatic curve, and a distortion curve of the optical imaging lens assembly according to Embodiment 3 respectively;

FIG. 7 shows a structure diagram of an optical imaging lens assembly according to Embodiment 4 of the disclosure;

FIGS. 8A to 8C show a longitudinal aberration curve, an astigmatic curve, and a distortion curve of the optical imaging lens assembly according to Embodiment 4 respectively;

FIG. 9 shows a structure diagram of an optical imaging lens assembly according to Embodiment 5 of the disclosure;

FIGS. 10A to 10C show a longitudinal aberration curve, an astigmatic curve, and a distortion curve of the optical imaging lens assembly according to Embodiment 5 respectively;

FIG. 11 shows a structure diagram of an optical imaging lens assembly according to Embodiment 6 of the disclosure;

FIGS. 12A to 12C show a longitudinal aberration curve, an astigmatic curve, and a distortion curve of the optical imaging lens assembly according to Embodiment 6 respectively;

FIG. 13 shows a structure diagram of an optical imaging lens assembly according to Embodiment 7 of the disclosure;

FIGS. 14A to 14C show a longitudinal aberration curve, an astigmatic curve, and a distortion curve of the optical imaging lens assembly according to Embodiment 7 respectively;

FIG. 15 shows a structure diagram of an optical imaging lens assembly according to Embodiment 8 of the disclosure;

FIGS. 16A to 16C show a longitudinal aberration curve, an astigmatic curve, and a distortion curve of the optical imaging lens assembly according to Embodiment 8 respectively;

FIG. 17 shows a structure diagram of an optical imaging lens assembly according to Embodiment 9 of the disclosure;

FIGS. 18A to 18C show a longitudinal aberration curve, an astigmatic curve, and a distortion curve of the optical imaging lens assembly according to Embodiment 9 respectively;

### DETAILED DESCRIPTION OF THE EMBODIMENTS

In order to understand the disclosure better, more detailed descriptions will be made to each aspect of the disclosure with reference to the drawings. It is to be understood that these detailed descriptions are only descriptions about the exemplary embodiments of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It is also to be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and features in the embodiments may be combined without conflicts. The disclosure will be described below with reference to the drawings and in combination with the embodiments in detail.

The features, principles and other aspects of the disclosure will be described below in detail.

According to exemplary embodiments of the disclosure, an optical imaging lens assembly may include, for example, four lenses with refractive power: a first lens, a second lens, a third lens, and a fourth lens respectively. The four lenses are sequentially arranged from an object side to an image side along an optical axis. There may be a spacing distance between any two adjacent lenses in the first lens to the fourth lens.

In an exemplary embodiment, the third lens may have a positive refractive power; the fourth lens may have a negative refractive power, and its object-side surface may be a convex surface.

In an exemplary embodiment, the optical imaging lens assembly according to the disclosure may meet: 20 mm<F<30 mm, where f is a total effective focal length of the optical imaging lens assembly. More specifically, f further meets 22 mm<f<30 mm. 20 mm<f<30 mm is favorable for achieving a feature of excessively large focal length of the optical imaging lens assembly at the same time of ensuring the miniaturization of the optical imaging lens assembly.

In an exemplary embodiment, the optical imaging lens assembly according to the disclosure may meet: −1.7<(R7−R8)/f4<0, where R7 is a curvature radius of the object-side surface of the fourth lens; R8 is a curvature radius of an image-side surface of the fourth lens; and f4 is an effective focal length of the fourth lens. Meeting −1.7<(R7−R8)/f4<0 can effectively correct the astigmatism of the optical imaging lens assembly, thus ensuring the imaging quality of the margin field of the optical imaging lens assembly.

In an exemplary embodiment, the optical imaging lens assembly according to the disclosure may meet: 10°<FOV<15°, where FOV is the maximum field of view of the optical imaging lens assembly. Meeting 10°<FOV<15° can ensure that the focal length of the optical imaging lens assembly is within the specific range, thus meeting the large focal length of the optical imaging lens assembly. The optical imaging lens assembly according to the disclosure can be used in conjunction with a short-focus wide-angle lens, thus realizing a larger optical zoom ratio.

In an exemplary embodiment, the optical imaging lens assembly according to the disclosure may meet: 1.2<f3/(DT31+DT32)<2.3, where f3 is an effective focal length of the third lens; DT31 is an effective radius of an object-side surface of the third lens; and DT32 is an effective radius of an image-side surface of the third lens. Meeting 1.2<f3/(DT31+DT32)<2.3 can increase relative illumination of the optical imaging lens assembly, thus improving the imaging quality of the optical imaging lens assembly in a dark environment.

In an exemplary embodiment, the optical imaging lens assembly according to the disclosure may meet: 0.8<DT11/DT41<1.2, where DT11 is an effective radius of an object-side surface of the first lens; and DT41 is an effective radius of the object-side surface of the fourth lens. Meeting 0.8<DT11/DT41<1.2 can effectively reduce the size of the optical imaging lens assembly, thus ensuring the miniaturization and improving the resolution of the lens.

In an exemplary embodiment, the optical imaging lens assembly according to the disclosure may meet: 1.8<(N1+N2+N3+N4)/4<2.0, where N1 is a refractive index of the first lens; N2 is a refractive index of the second lens; N3 is a refractive index of the third lens; and N4 is a refractive index of the fourth lens. More specifically, N1, N2, N3, and N4 further meet 1.90<(N1+N2+N3+N4)/4<1.95. Meeting 1.8<(N1+N2+N3+N4)/4<2.0 allows effective distribution of the refractive power of each lens, and ensures better imaging quality of the system and better effect of eliminating temperature drift.

In an exemplary embodiment, the optical imaging lens assembly according to the disclosure may include a diaphragm used for adjusting the amount of light. The optical imaging lens assembly according to the disclosure may meet: 0.1<(CT1+CT2)/(TTL−SL)<0.9, where CT1 is a center thickness of the first lens on the optical axis; CT2 is a center thickness of the second lens on the optical axis; TTL is a distance from the object-side surface of the first lens to an imaging surface of the optical imaging lens assembly on the optical axis; and SL is a distance from the diaphragm to the imaging surface on the optical axis. The diaphragm-related aberration (e.g., coma, astigmatism, distortion and longitudinal aberration) of the optical imaging lens assembly can be effectively corrected by selecting an appropriate diaphragm position. Meanwhile, reasonable control of the center thickness of the first lens and the second lens can effectively improve the field curvature of the optical imaging lens assembly. Optionally, the diaphragm may be set between the second lens and the third lens.

In an exemplary embodiment, the optical imaging lens assembly according to the disclosure may meet: 0.7<BFL/f<1.2 mm, where BFL is a distance from the image-side surface of the fourth lens to the imaging surface on the optical axis, and f is the total effective focal length of the optical imaging lens assembly. Meeting 0.7<BFL/f<1.2 mm allows the optical imaging lens assembly to have a ultra-long effective focal length and a ultra-long back focal length, which is convenient for the later module assembly of the optical imaging lens assembly.

In an exemplary embodiment, the optical imaging lens assembly according to the disclosure may meet: 0.4<(SAG41+SAG42)/ImgH<1.6, where SAG41 is a distance on the optical axis from an intersection point of the object-side surface of the fourth lens and the optical axis to an effective radius vertex of the object-side surface of the fourth lens; SAG42 is a distance on the optical axis from an intersection point of the image-side surface of the fourth lens and the optical axis to an effective radius vertex of the image-side surface of the fourth lens; and ImgH is a half of a diagonal length of an effective pixel region on the imaging surface. Meeting 0.4<(SAG41+SAG42)/ImgH<1.6 can avoid the excessive bending of the fourth lens, reduce the processing difficulty and reduce the spherical aberration of the optical imaging lens assembly; it can also improve the effective focal length of the optical imaging lens assembly on the premise of maintaining the imaging quality of the optical imaging lens assembly; it can also increase the relative illumination of the optical imaging lens assembly and improve the imaging quality of the lens in a dark environment.

In an exemplary embodiment, the optical imaging lens assembly according to the disclosure may meet: 0.1<|SAG11|/(CT1+T12)<0.8, where SAG11 is a distance on the optical axis from an intersection point of the object-side surface of the first lens and the optical axis to an effective radius vertex of the object-side surface of the first lens; CT1 is the center thickness of the first lens on the optical axis; and T12 is a distance between the first lens and the second lens on the optical axis. Meeting 0.1<|SAG11|/(CT1+T12)<0.8 can ensure the processing, molding and assembly of the first lens, thus ensuring high imaging quality of the optical imaging lens assembly. Unreasonable ratio may lead to difficulty in adjusting the formed surface type and deformation after assembly, so the imaging quality cannot be guaranteed.

In an exemplary embodiment, at least three lenses of the first lens to the fourth lens may be made of a glass material. The glass material is relatively wide in refractive index range and relatively high in selectivity, so that using the glass material may improve the performance of the optical imaging lens assembly effectively. Moreover, an expansion coefficient of glass is lower than that of plastic, so that using the glass material in the optical imaging lens assembly may eliminate a temperature drift better. More specifically, the first lens to the fourth lens may all be made of the glass material.

In an exemplary embodiment, an object-side surface and an image-side surface of at least one of the first lens to the fourth lens can be a spherical surface. Setting an object-side surface and an image-side surface of at least one of the first lens to the fourth lens as spherical can be beneficial to the processing of the optical imaging lens assembly and reduce the processing cost. Optionally, the object-side surface and the image-side surface of all the four lenses are spherical surfaces.

Optionally, the optical imaging lens assembly may further include an optical filter for correcting color deviation and/or protective glass for protecting a photosensitive element located on the imaging surface.

The disclosure provides a four-piece glass telephoto optical imaging lens assembly group. Large focal length and high resolution can be achieved for the optical imaging lens assembly by reasonably distributing the refractive power, surface shape, center thickness and curvature radius of the lenses and the distance between the lenses on the axis, etc., with low degree of design freedom.

However, those skilled in the art should know that the number of the lenses forming the optical imaging lens assembly may be changed without departing from the technical solutions claimed in the disclosure to achieve each result and advantage described in the specification. For example, although descriptions are made in the embodiment with four lenses as an example, the optical imaging lens assembly is not limited to four lenses. If necessary, the optical imaging lens assembly may also include another number of lenses.

Specific embodiments applicable to the optical imaging lens assembly of the above-mentioned implementation mode will further be described below with reference to the drawings.

### Embodiment 1

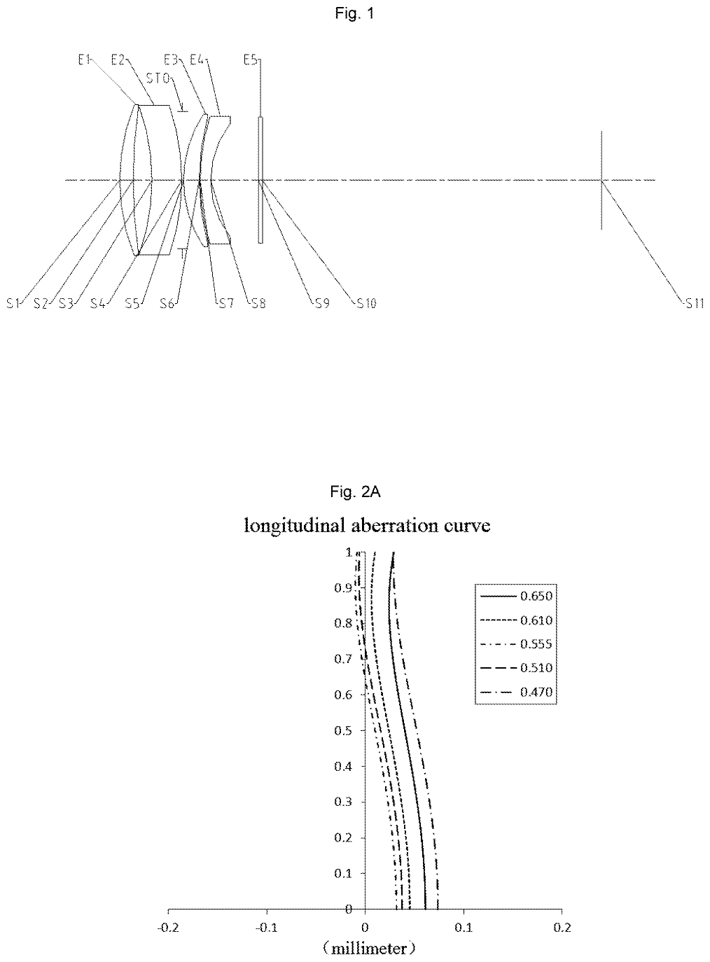

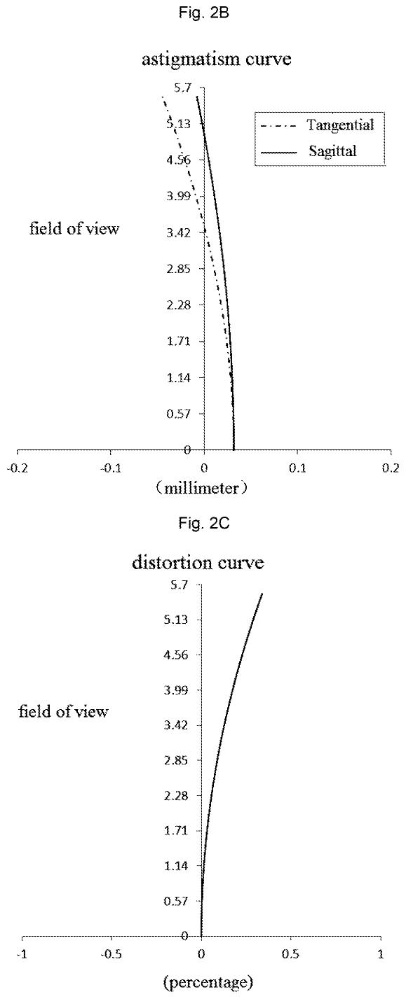

An optical imaging lens assembly according to embodiment 1 of the disclosure is described below with reference to FIG. 1 to FIG. 2C. FIG. 1 shows a structure diagram of an optical imaging lens assembly according to embodiment 1 of the disclosure.

As shown in FIG. 1, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a positive refractive power, wherein an object-side surface S1 thereof is a convex surface, and an image-side surface S2 thereof is a concave surface. The second lens E2 has a positive refractive power, wherein an object-side surface S3 thereof is a concave surface, and an image-side surface S4 thereof is a convex surface. The third lens E3 has a positive refractive power, wherein an object-side surface S5 thereof is a convex surface, and an image-side surface S6 thereof is a concave surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

Table 1 shows basic parameters of the optical imaging lens assembly according to embodiment 1. The units of curvature radius, thickness/distance, focal length, and effective radius are millimeters (mm).

TABLE 1

| Surface | Surface | Curvature | Thickness/ | | Refractive | Abbe | Focal | Effective |
|---|---|---|---|---|---|---|---|---|
| number. | type | radius | distance | Material | index | number | length | radius |
| OBJ | Spherical | Infinity | Infinity | | | | | |
| S1 | Spherical | 11.1394 | 0.7465 | Glass | 2.01 | 29.1 | 17.67 | 4.1750 |
| S2 | Spherical | 28.7736 | 1.0286 | | | | | 4.1181 |
| S3 | Spherical | −12.3303 | 1.6377 | Glass | 2.01 | 29.1 | 644.19 | 4.1082 |
| S4 | Spherical | −12.9068 | 0.0500 | | | | | 4.1417 |
| STO | Spherical | Infinity | 0.0500 | | | | | 3.8027 |
| S5 | Spherical | 6.6642 | 0.8642 | Glass | 1.76 | 52.3 | 16.49 | 3.6657 |
| S6 | Spherical | 13.4809 | 0.0500 | | | | | 3.5806 |
| S7 | Spherical | 11.6986 | 0.5794 | Glass | 1.93 | 20.9 | −10.26 | 3.5363 |
| S8 | Spherical | 5.1333 | 2.6268 | | | | | 3.1425 |
| S9 | Spherical | Infinity | 0.2100 | Glass | 1.52 | 64.2 | | 3.5000 |
| S10 | Spherical | Infinity | 18.6567 | | | | | 3.5000 |
| S11 | Spherical | Infinity | | | | | | 2.7449 |

In this example, the total effective focal length f of the optical imaging lens assembly is 27.50 mm; TTL is the total length of the optical imaging lens assembly (i.e., the distance from the object-side surface S1 of the first lens E1 to the imaging surface S11 of the optical imaging lens assembly on the optical axis), and TTL is 26.50 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 11.23°.

FIG. 2A shows a longitudinal aberration curve of the optical imaging lens assembly according to embodiment 1 to represent deviations of a convergence focal point after light with different wavelengths passes through the lens. FIG. 2B shows an astigmatic curve of the optical imaging lens assembly according to embodiment 1 to represent a tangential image surface curvature and a sagittal image surface curvature. FIG. 2C shows a distortion curve of the optical imaging lens assembly according to embodiment 1 to represent distortion values corresponding to different fields of views. As we can see from FIGS. 2A to 2C, the optical imaging lens assembly according to embodiment 1 can achieve high imaging quality.

### Embodiment 2

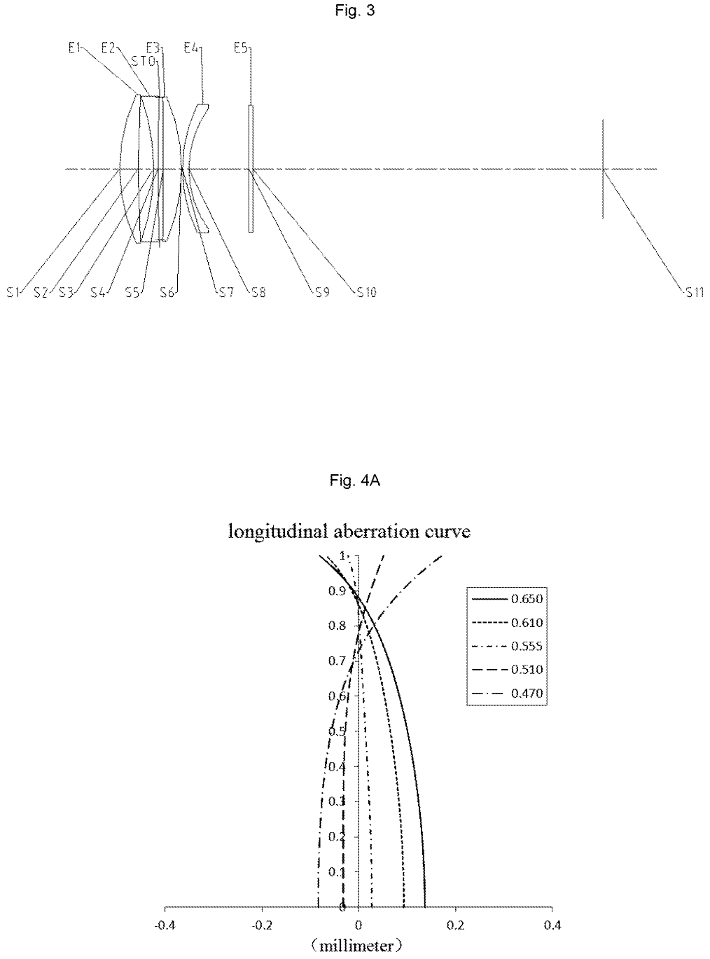

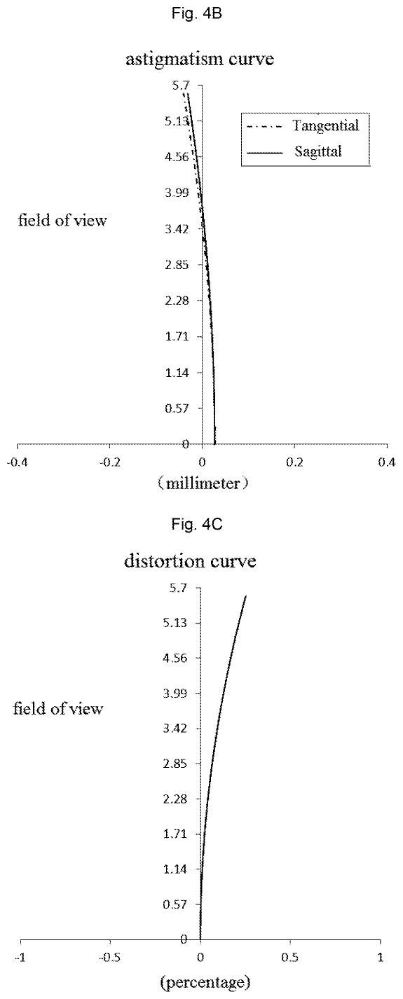

An optical imaging lens assembly according to embodiment 2 of the disclosure is described below with reference to FIG. 3 to FIG. 4C. FIG. 3 shows a structure diagram of an optical imaging lens assembly according to embodiment 2 of the disclosure.

As shown in FIG. 3, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a positive refractive power, wherein an object-side surface S1 thereof is a convex surface, and an image-side surface S2 thereof is a concave surface. The second lens E2 has a negative refractive power, wherein an object-side surface S3 thereof is a concave surface, and an image-side surface S4 thereof is a concave surface. The third lens E3 has a positive refractive power, wherein an object-side surface S5 thereof is a concave surface, and an image-side surface S6 thereof is a convex surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 27.50 mm; TTL is the total length of the optical imaging lens assembly, and TTL is 26.57 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 11.24°.

Table 2 shows basic parameters of the optical imaging lens assembly according to embodiment 2. The units of curvature radius, thickness/distance, focal length, and effective radius are millimeters (mm).

TABLE 2

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | 9.6444 | 1.0150 | Glass | 2.01 | 29.1 | 11.15 | 4.0934 |
| S2 | Spherical | 64.8569 | 0.8530 | | | | | 4.0301 |
| S3 | Spherical | −11.9449 | 0.2400 | Glass | 2.01 | 29.1 | −11.01 | 4.0124 |
| S4 | Spherical | 155.6927 | 0.0998 | | | | | 3.9766 |
| STO | Spherical | Infinity | 0.1966 | | | | | 3.9118 |
| S5 | Spherical | −215.5270 | 0.9982 | Glass | 1.76 | 52.3 | 13.97 | 3.9675 |
| S6 | Spherical | −10.1067 | 0.0500 | | | | | 3.9637 |
| S7 | Spherical | 8.0144 | 0.3530 | Glass | 1.93 | 20.9 | −22.56 | 3.5389 |
| S8 | Spherical | 5.6777 | 3.3013 | | | | | 3.3315 |
| S9 | Spherical | Infinity | 0.2100 | Glass | 1.52 | 64.2 | | 3.5000 |
| S10 | Spherical | Infinity | 19.2531 | | | | | 3.5000 |
| S11 | Spherical | Infinity | | | | | | 2.7430 |

FIG. 4A shows a longitudinal aberration curve of the optical imaging lens assembly according to embodiment 2 to represent deviations of a convergence focal point after light with different wavelengths passes through the lens. FIG. 4B shows an astigmatic curve of the optical imaging lens assembly according to embodiment 2 to represent a tangential image surface curvature and a sagittal image surface curvature. FIG. 4C shows a distortion curve of the optical imaging lens assembly according to embodiment 2 to represent distortion values corresponding to different fields of views. As we can see from FIGS. 4A to 4C, the optical imaging lens assembly according to embodiment 2 can achieve high imaging quality.

### Embodiment 3

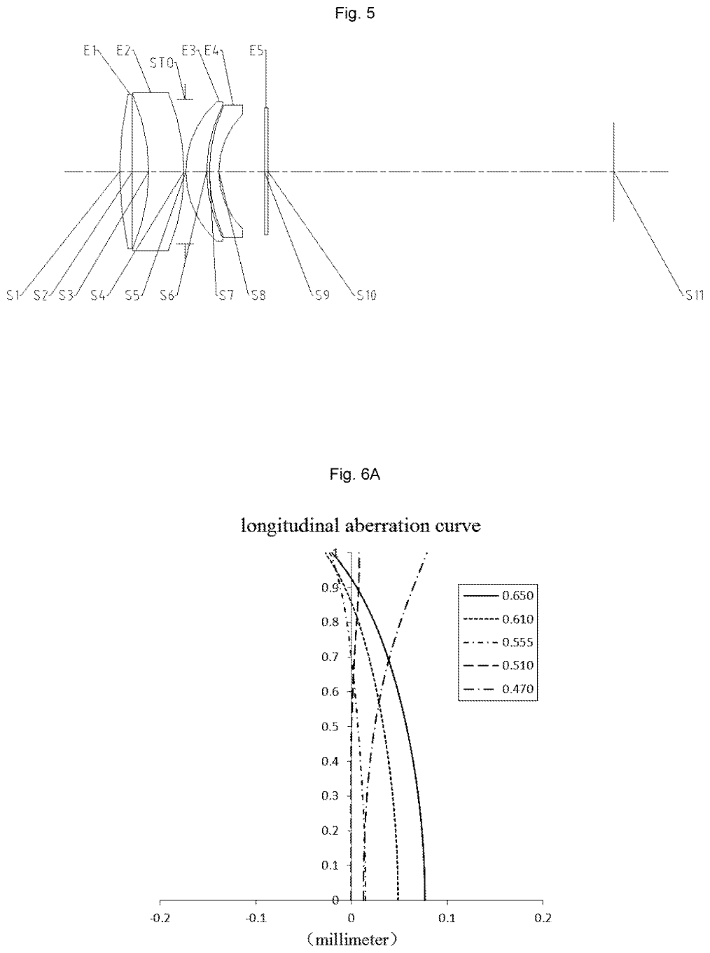

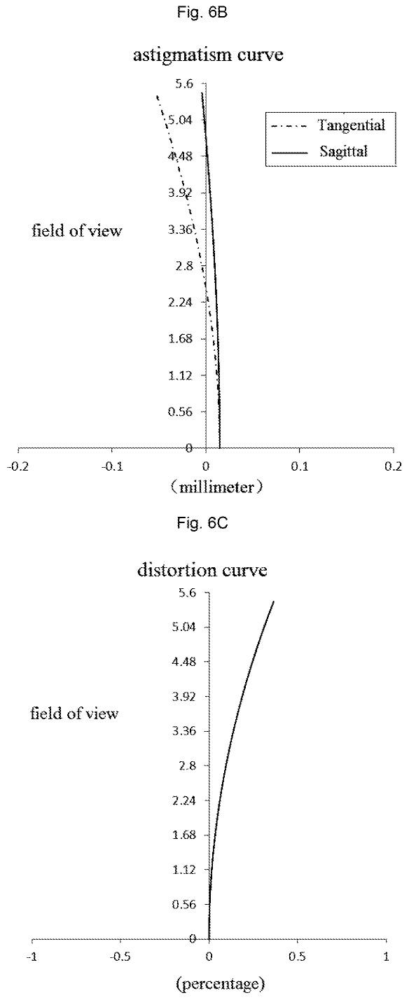

An optical imaging lens assembly according to embodiment 3 of the disclosure is described below with reference to FIG. 5 to FIG. 6C. FIG. 5 shows a structure diagram of an optical imaging lens assembly according to embodiment 3 of the disclosure.

As shown in FIG. 5, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a positive refractive power, wherein an object-side surface S1 thereof is a convex surface, and an image-side surface S2 thereof is a convex surface. The second lens E2 has a positive refractive power, wherein an object-side surface S3 thereof is a concave surface, and an image-side surface S4 thereof is a convex surface. The third lens E3 has a positive refractive power, wherein an object-side surface S5 thereof is a convex surface, and an image-side surface S6 thereof is a concave surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 28.00 mm; TTL is the total length of the optical imaging lens assembly, and TTL is 27.20 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 11.02°.

Table 3 shows basic parameters of the optical imaging lens assembly according to embodiment 3. The units of curvature radius, thickness/distance, focal length, and effective radius are millimeters (mm).

TABLE 3

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | 19.9729 | 0.7033 | Glass | 2.01 | 29.1 | 19.45 | 4.2644 |
| S2 | Spherical | −1000.0000 | 0.8940 | | | | | 4.2278 |
| S3 | Spherical | −10.6825 | 1.9418 | Glass | 2.01 | 29.1 | 638.08 | 4.2160 |
| S4 | Spherical | −11.4663 | 0.0500 | | | | | 4.3519 |
| STO | Spherical | Infinity | 0.0500 | | | | 16.52 | 3.9683 |
| S5 | Spherical | 5.2137 | 1.1479 | Glass | 1.76 | 52.3 | | 3.8387 |
| S6 | Spherical | 8.0874 | 0.1503 | | | | | 3.6762 |
| S7 | Spherical | 8.9022 | 0.5164 | Glass | 1.93 | 20.9 | −10.29 | 3.6538 |
| S8 | Spherical | 4.4839 | 2.5039 | | | | | 3.1833 |
| S9 | Spherical | Infinity | 0.2100 | Glass | 1.52 | 64.2 | | 3.5000 |
| S10 | Spherical | Infinity | 19.0324 | | | | | 3.5000 |
| S11 | Spherical | Infinity | | | | | | 2.7558 |

FIG. 6A shows a longitudinal aberration curve of the optical imaging lens assembly according to embodiment 3 to represent deviations of a convergence focal point after light with different wavelengths passes through the lens. FIG. 6B shows an astigmatic curve of the optical imaging lens assembly according to embodiment 3 to represent a tangential image surface curvature and a sagittal image surface curvature. FIG. 6C shows a distortion curve of the optical imaging lens assembly according to embodiment 3 to represent distortion values corresponding to different fields of views. As we can see from FIGS. 6A to 6C, the optical imaging lens assembly according to embodiment 3 can achieve high imaging quality.

### Embodiment 4

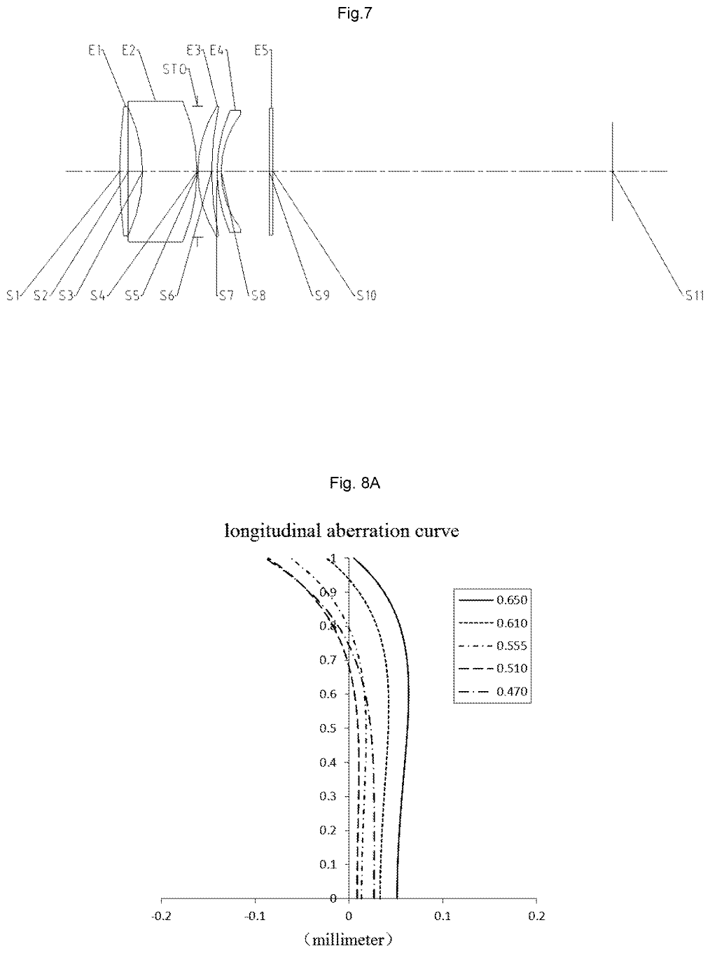

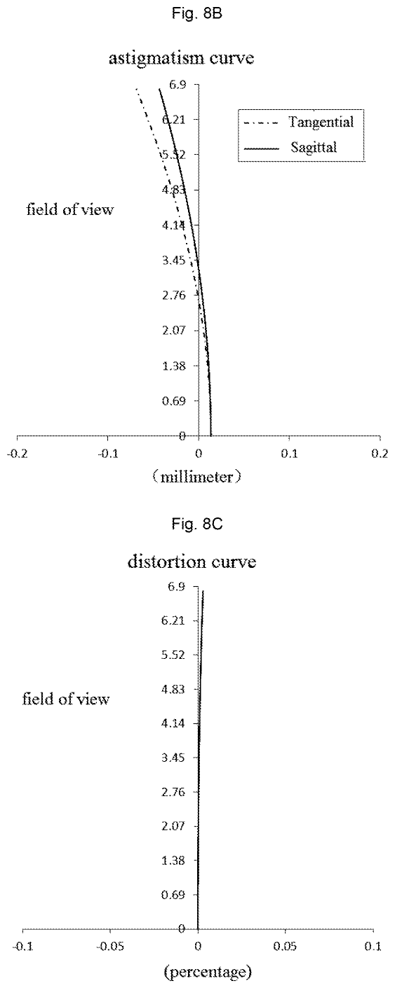

An optical imaging lens assembly according to embodiment 4 of the disclosure is described below with reference to FIG. 7 to FIG. 8C. FIG. 7 shows a structure diagram of an optical imaging lens assembly according to embodiment 4 of the disclosure.

As shown in FIG. 7, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a positive refractive power, wherein an object-side surface S1 thereof is a convex surface, and an image-side surface S2 thereof is a convex surface. The second lens E2 has a negative refractive power, wherein an object-side surface S3 thereof is a concave surface, and an image-side surface S4 thereof is a convex surface. The third lens E3 has a positive refractive power, wherein an object-side surface S5 thereof is a convex surface, and an image-side surface S6 thereof is a concave surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 22.48 mm; TTL is the total length of the optical imaging lens assembly, and TTL is 27.13 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 13.76°.

Table 4 shows basic parameters of the optical imaging lens assembly according to embodiment 4. The units of curvature radius, thickness/distance, focal length, and effective radius are millimeters (mm).

TABLE 4

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | 28.6318 | 0.4812 | Glass | 2.01 | 29.1 | 25.97 | 3.5466 |
| S2 | Spherical | −300.0000 | 0.7784 | | | | | 3.5171 |
| S3 | Spherical | −8.2340 | 2.9974 | Glass | 2.01 | 29.1 | −834.32 | 3.5141 |
| S4 | Spherical | −9.8344 | 0.0250 | | | | | 3.8649 |
| STO | Spherical | Infinity | 0.0250 | | | | | 3.6038 |
| S5 | Spherical | 6.7423 | 0.7490 | Glass | 1.76 | 52.3 | 14.54 | 3.5606 |
| S6 | Spherical | 16.5549 | 0.3000 | | | | | 3.5321 |
| S7 | Spherical | 8.2657 | 0.2250 | Glass | 1.93 | 20.9 | −15.33 | 3.3578 |
| S8 | Spherical | 5.1656 | 2.6528 | | | | | 3.1507 |
| S9 | Spherical | Infinity | 0.2100 | Glass | 1.52 | 64.2 | | 3.5000 |
| S10 | Spherical | Infinity | 18.6827 | | | | | 3.5000 |
| S11 | Spherical | Infinity | | | | | | 2.7204 |

FIG. 8A shows a longitudinal aberration curve of the optical imaging lens assembly according to embodiment 4 to represent deviations of a convergence focal point after light with different wavelengths passes through the lens. FIG. 8B shows an astigmatic curve of the optical imaging lens assembly according to embodiment 4 to represent a tangential image surface curvature and a sagittal image surface curvature. FIG. 8C shows a distortion curve of the optical imaging lens assembly according to embodiment 4 to represent distortion values corresponding to different fields of views. As we can see from FIGS. 8A to 8C, the optical imaging lens assembly according to embodiment 4 can achieve high imaging quality.

### Embodiment 5

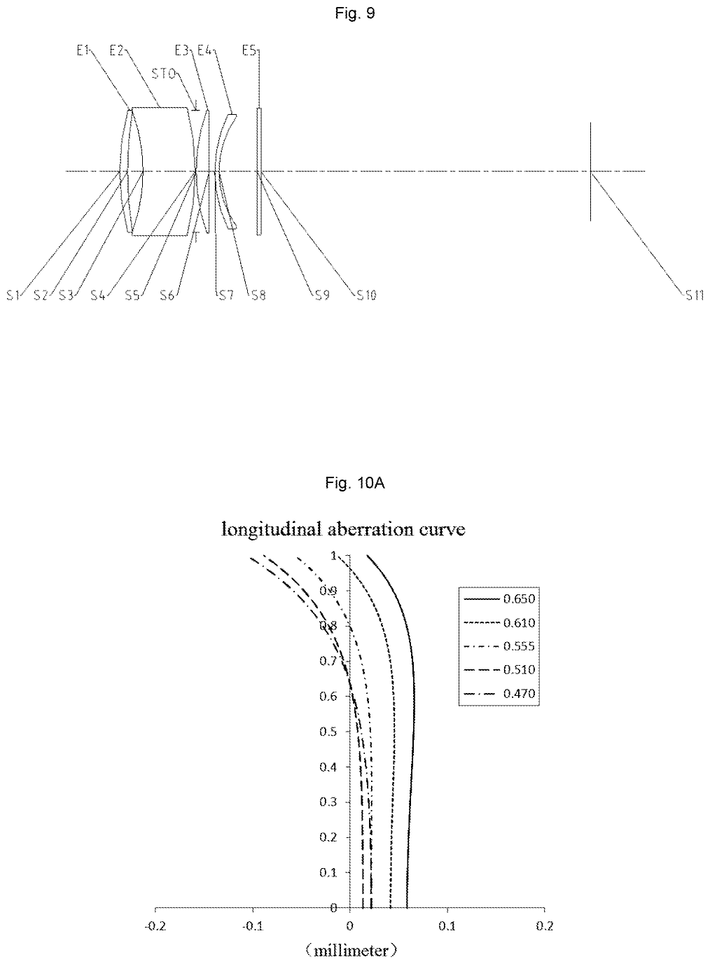

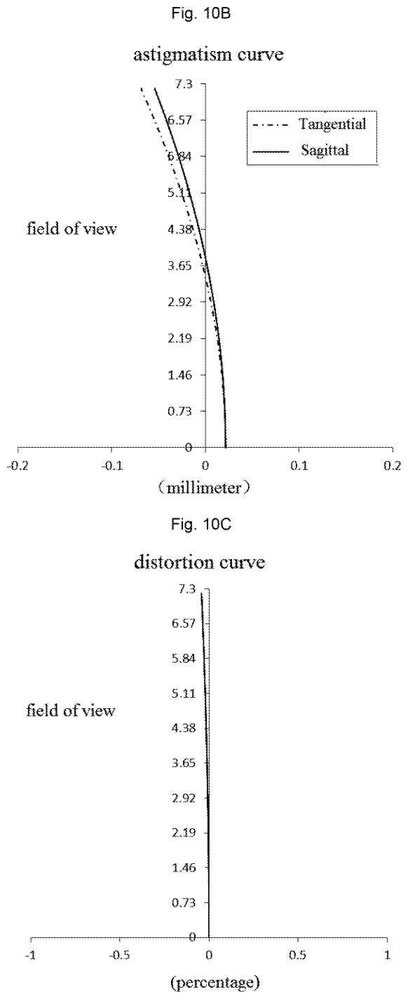

An optical imaging lens assembly according to embodiment 5 of the disclosure is described below with reference to FIG. 9 to FIG. 10C. FIG. 9 shows a structure diagram of an optical imaging lens assembly according to embodiment 5 of the disclosure.

As shown in FIG. 9, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a positive refractive power, wherein an object-side surface S1 thereof is a convex surface, and an image-side surface S2 thereof is a concave surface. The second lens E2 has a negative refractive power, wherein an object-side surface S3 thereof is a concave surface, and an image-side surface S4 thereof is a convex surface. The third lens E3 has a positive refractive power, wherein an object-side surface S5 thereof is a convex surface, and an image-side surface S6 thereof is a convex surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 21.25 mm; TTL is the total length of the optical imaging lens assembly, and TTL is 25.90 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 14.56°.

Table 5 shows basic parameters of the optical imaging lens assembly according to embodiment 5. The units of curvature radius, thickness/distance, focal length, and effective radius are millimeters (mm).

TABLE 5

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | 12.7162 | 0.4360 | Glass | 2.01 | 29.1 | 30.40 | 3.3622 |
| S2 | Spherical | 21.3735 | 0.8523 | | | | | 3.3138 |
| S3 | Spherical | −9.6743 | 2.8705 | Glass | 2.01 | 29.1 | −46.75 | 3.3115 |
| S4 | Spherical | −13.9890 | 0.0250 | | | | | 3.5245 |
| STO | Spherical | Infinity | 0.0250 | | | | | 3.3674 |
| S5 | Spherical | 9.9983 | 0.7273 | Glass | 1.76 | 52.3 | 12.70 | 3.3866 |
| S6 | Spherical | −250.0000 | 0.3000 | | | | | 3.3610 |
| S7 | Spherical | 7.2173 | 0.2250 | Glass | 1.93 | 20.9 | −21.18 | 3.1507 |
| S8 | Spherical | 5.2037 | 2.1011 | | | | | 3.0026 |
| S9 | Spherical | Infinity | 0.2100 | Glass | 1.52 | 64.2 | | 3.5000 |
| S10 | Spherical | Infinity | 18.1309 | | | | | 3.5000 |
| S11 | Spherical | Infinity | | | | | | 2.7261 |

FIG. 10A shows a longitudinal aberration curve of the optical imaging lens assembly according to embodiment 5 to represent deviations of a convergence focal point after light with different wavelengths passes through the lens. FIG. 10B shows an astigmatic curve of the optical imaging lens assembly according to embodiment 5 to represent a tangential image surface curvature and a sagittal image surface curvature. FIG. 10C shows a distortion curve of the optical imaging lens assembly according to embodiment 5. The curve shows distortion values corresponding to different image heights. As we can see from FIGS. 10A to 10C, the optical imaging lens assembly according to embodiment 5 can achieve high imaging quality.

### Embodiment 6

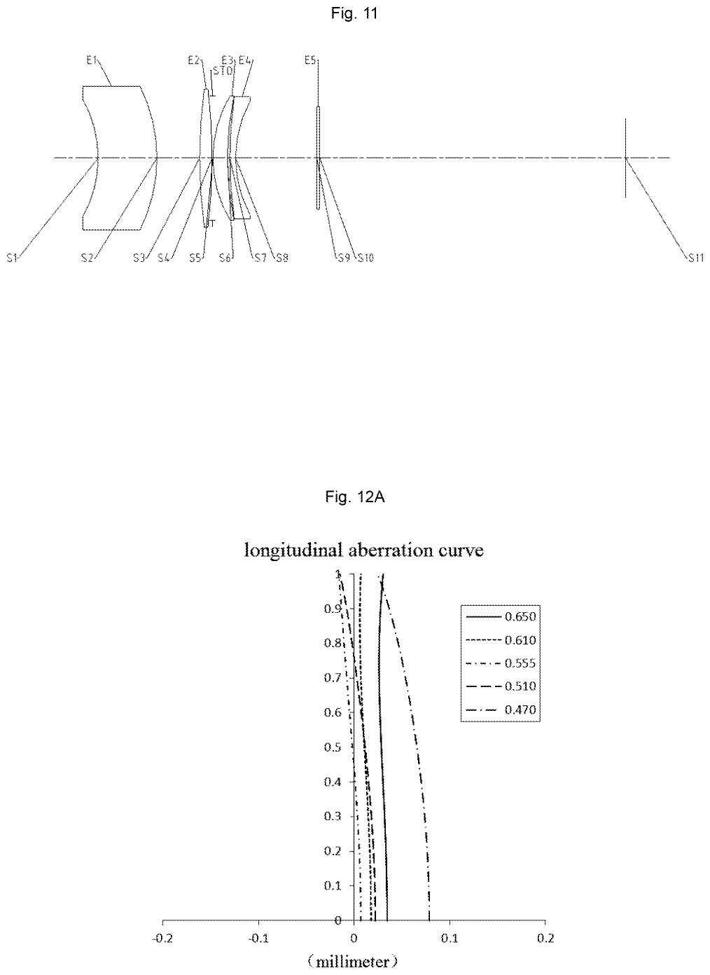

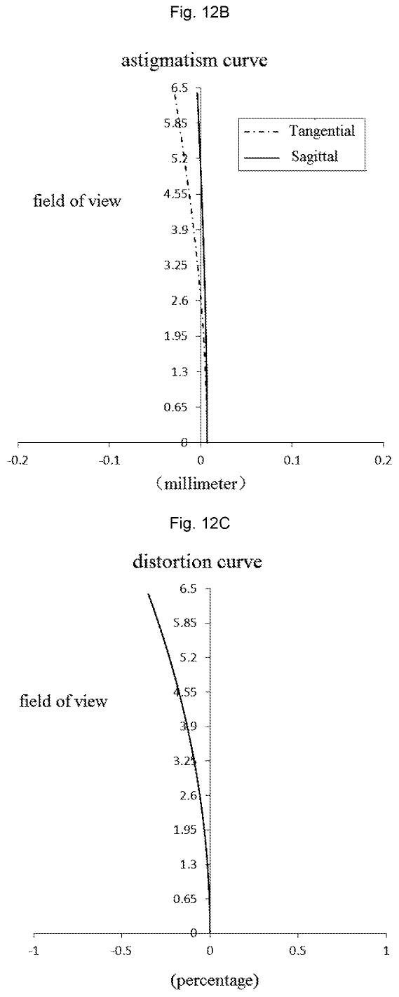

An optical imaging lens assembly according to embodiment 6 of the disclosure is described below with reference to FIG. 11 to FIG. 12C. FIG. 11 shows a structure diagram of an optical imaging lens assembly according to embodiment 6 of the disclosure.

As shown in FIG. 11, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a negative refractive power, wherein an object-side surface S1 thereof is a concave surface, and an image-side surface S2 thereof is a convex surface. The second lens E2 has a positive refractive power, wherein an object-side surface S3 thereof is a convex surface, and an image-side surface S4 thereof is a convex surface. The third lens E3 has a positive refractive power, wherein an object-side surface S5 thereof is a convex surface, and an image-side surface S6 thereof is a concave surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 24.00 mm; TTL is the total length of the optical imaging lens assembly, and TTL is 35.90 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 12.93°.

Table 6 shows basic parameters of the optical imaging lens assembly according to embodiment 6. The units of curvature radius, thickness/distance, focal length, and effective radius are millimeters (mm).

TABLE 6

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | −8.2041 | 4.0000 | Glass | 2.01 | 29.1 | −109.35 | 4.0330 |
| S2 | Spherical | −11.0331 | 2.9126 | | | | | 4.9106 |
| S3 | Spherical | 35.4697 | 0.8481 | Glass | 2.01 | 29.1 | 18.56 | 4.7210 |
| S4 | Spherical | −39.0353 | 0.0250 | | | | | 4.6987 |
| STO | Spherical | Infinity | 0.0250 | | | | | 4.2548 |
| S5 | Spherical | 8.2792 | 0.9894 | Glass | 1.76 | 52.3 | 17.88 | 4.2589 |
| S6 | Spherical | 20.1873 | 0.1631 | | | | | 4.1809 |
| S7 | Spherical | 29.0273 | 0.3937 | Glass | 1.93 | 20.9 | −12.31 | 4.1704 |
| S8 | Spherical | 8.1622 | 5.5216 | | | | | 3.8784 |
| S9 | Spherical | Infinity | 0.2100 | Glass | 1.52 | 64.2 | | 3.5000 |
| S10 | Spherical | Infinity | 20.8101 | | | | | 3.5000 |
| S11 | Spherical | Infinity | | | | | | 2.7395 |

FIG. 12A shows a longitudinal aberration curve of the optical imaging lens assembly according to embodiment 6 to represent deviations of a convergence focal point after light with different wavelengths passes through the lens. FIG. 12B shows an astigmatic curve of the optical imaging lens assembly according to embodiment 6 to represent a tangential image surface curvature and a sagittal image surface curvature. FIG. 12C shows a distortion curve of the optical imaging lens assembly according to embodiment 6 to represent distortion values corresponding to different fields of views. As we can see from FIGS. 12A to 12C, the optical imaging lens assembly according to embodiment 6 can achieve high imaging quality.

### Embodiment 7

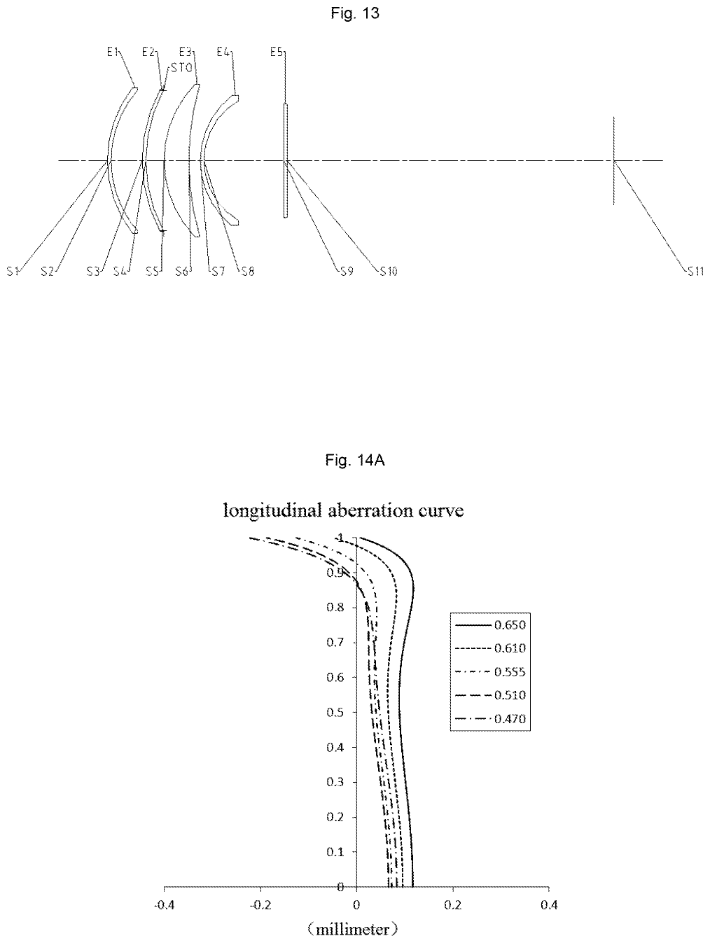

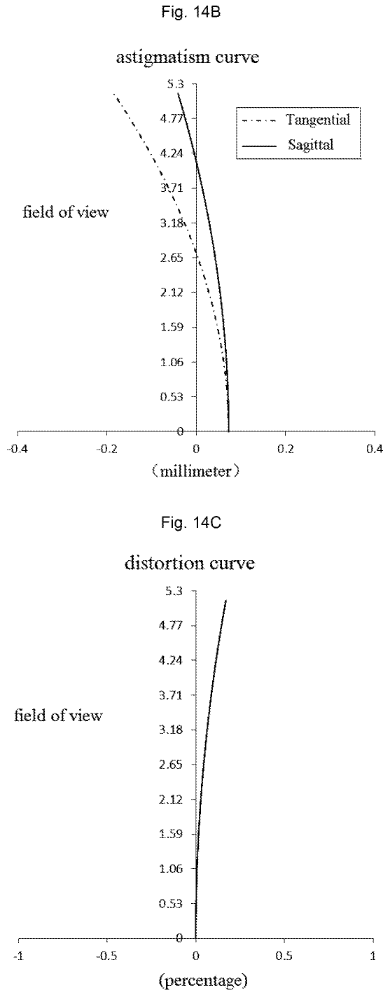

An optical imaging lens assembly according to embodiment 7 of the disclosure is described below with reference to FIG. 13 to FIG. 14C. FIG. 13 shows a structure diagram of an optical imaging lens assembly according to embodiment 7 of the disclosure.

As shown in FIG. 13, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a negative refractive power, wherein an object-side surface S1 thereof is a convex surface, and an image-side surface S2 thereof is a concave surface. The second lens E2 has a positive refractive power, wherein an object-side surface S3 thereof is a convex surface, and an image-side surface S4 thereof is a concave surface. The third lens E3 has a positive refractive power, wherein an object-side surface S5 thereof is a convex surface, and an image-side surface S6 thereof is a concave surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 29.75 mm; TTL is the total length of the optical imaging lens assembly, and TTL is 31.30 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 10.42°.

Table 7 shows basic parameters of the optical imaging lens assembly according to embodiment 7. The units of curvature radius, thickness/distance, focal length, and effective radius are millimeters (mm).

TABLE 7

| Surface | Surface | Curvature | Thickness/ | | Refractive | Abbe | Focal | Effective |
|---|---|---|---|---|---|---|---|---|
| number | type | radius | distance | Material | index | number | length | half aperture |
| OBJ | Spherical | Infinity | Infinity | | | | | |
| S1 | Spherical | 7.2445 | 0.2250 | Glass | 2.01 | 29.1 | −79.06 | 4.4824 |
| S2 | Spherical | 6.5368 | 1.9191 | | | | | 4.3478 |
| S3 | Spherical | 9.1382 | 0.2290 | Glass | 2.01 | 29.1 | 493.93 | 4.3651 |
| S4 | Spherical | 9.1922 | 1.1009 | | | | | 4.3284 |
| STO | Spherical | Infinity | 0.0250 | | | | | 4.3060 |
| S5 | Spherical | 6.7312 | 1.5261 | Glass | 1.76 | 52.3 | 14.16 | 4.6776 |
| S6 | Spherical | 16.3055 | 0.7141 | | | | | 4.5893 |
| S7 | Spherical | 5.1095 | 0.2260 | Glass | 1.93 | 20.9 | −31.30 | 3.9951 |
| S8 | Spherical | 4.2543 | 4.9173 | | | | | 3.6943 |
| S9 | Spherical | Infinity | 0.2100 | Glass | 1.52 | 64.2 | | 3.5000 |
| S10 | Spherical | Infinity | 20.2058 | | | | | 3.5000 |
| S11 | Spherical | Infinity | | | | | | 2.7296 |

FIG. 14A shows a longitudinal aberration curve of the optical imaging lens assembly according to embodiment 7 to represent deviations of a convergence focal point after light with different wavelengths passes through the lens. FIG. 14B shows an astigmatic curve of the optical imaging lens assembly according to embodiment 7 to represent a tangential image surface curvature and a sagittal image surface curvature. FIG. 14C shows a distortion curve of the optical imaging lens assembly according to embodiment 7 to represent distortion values corresponding to different fields of views. As we can see from FIGS. 14A to 14C, the optical imaging lens assembly according to embodiment 7 can achieve high imaging quality.

### Embodiment 8

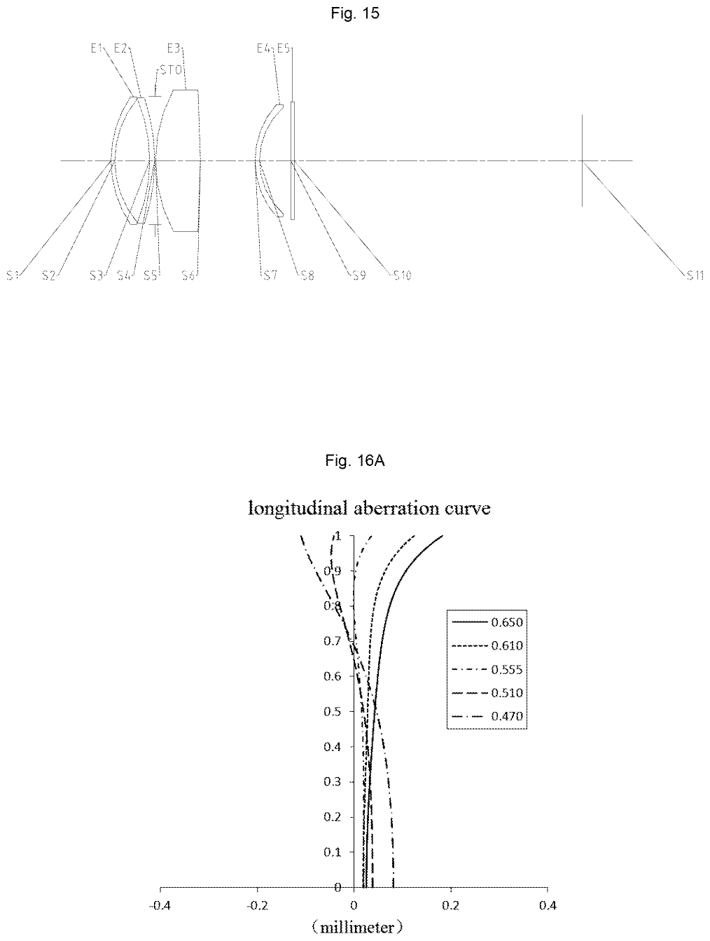

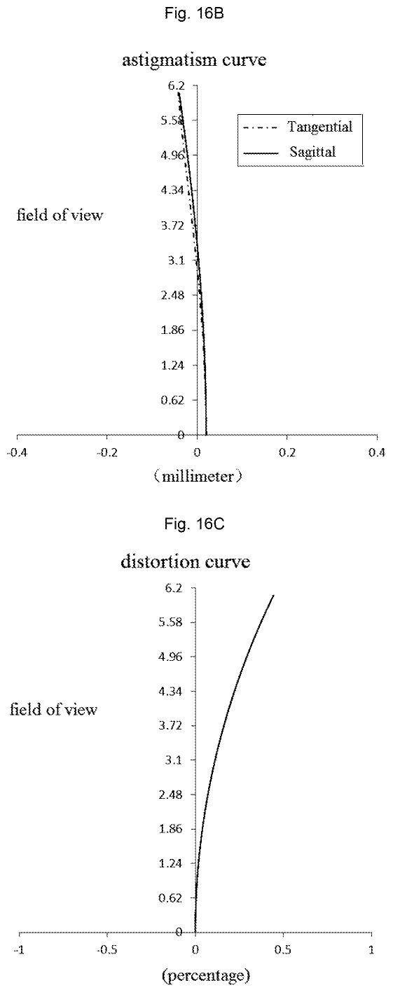

An optical imaging lens assembly according to embodiment 8 of the disclosure is described below with reference to FIG. 15 to FIG. 16C. FIG. 15 shows a structure diagram of an optical imaging lens assembly according to embodiment 8 of the disclosure.

As shown in FIG. 15, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a negative refractive power, wherein an object-side surface S1 thereof is a convex surface, and an image-side surface S2 thereof is a concave surface. The second lens E2 has a negative refractive power, wherein an object-side surface S3 thereof is a concave surface, and an image-side surface S4 thereof is a convex surface. The third lens E3 has a positive refractive power, wherein an object-side surface S5 thereof is a convex surface, and an image-side surface S6 thereof is a convex surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 25.14 mm; TTL is the total length of the optical imaging lens assembly, and TTL is 28.07 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 12.26°.

Table 8 shows basic parameters of the optical imaging lens assembly according to embodiment 8. The units of curvature radius, thickness/distance, focal length, and effective radius are millimeters (mm).

TABLE 8

| Surface | Surface | Curvature | Thickness/ | | Refractive | Abbe | Focal | Effective |
|---|---|---|---|---|---|---|---|---|
| number | type | radius | distance | Material | index | number | length | radius |
| OBJ | Spherical | Infinity | Infinity | | | | | |
| S1 | Spherical | 6.7785 | 0.2250 | Glass | 2.01 | 29.1 | −40.41 | 3.7812 |
| S2 | Spherical | 5.7139 | 2.0781 | | | | | 3.6395 |
| S3 | Spherical | −9.5474 | 0.2976 | Glass | 2.01 | 29.1 | −54.66 | 3.6406 |
| S4 | Spherical | −11.7310 | 0.0250 | | | | | 3.7290 |
| STO | Spherical | Infinity | 0.0250 | | | | | 3.8023 |
| S5 | Spherical | 8.8299 | 2.6743 | Glass | 1.76 | 52.3 | 10.37 | 4.2144 |
| S6 | Spherical | −61.8736 | 3.2569 | | | | | 4.1170 |
| S7 | Spherical | 4.9824 | 0.2668 | Glass | 1.93 | 20.9 | −37.00 | 3.3319 |
| S8 | Spherical | 4.2403 | 1.8637 | | | | | 3.1467 |
| S9 | Spherical | Infinity | 0.2100 | Glass | 1.52 | 64.2 | | 3.5000 |
| S10 | Spherical | Infinity | 17.1522 | | | | | 3.5000 |
| S11 | Spherical | Infinity | | | | | | 2.7296 |

FIG. 16A shows a longitudinal aberration curve of the optical imaging lens assembly according to embodiment 8 to represent deviations of a convergence focal point after light with different wavelengths passes through the lens. FIG. 16B shows an astigmatic curve of the optical imaging lens assembly according to embodiment 8 to represent a tangential image surface curvature and a sagittal image surface curvature. FIG. 16C shows a distortion curve of the optical imaging lens assembly according to embodiment 8 to represent distortion values corresponding to different fields of views. As we can see from FIGS. 16A to 16C, the optical imaging lens assembly according to embodiment 8 can achieve high imaging quality.

### Embodiment 9

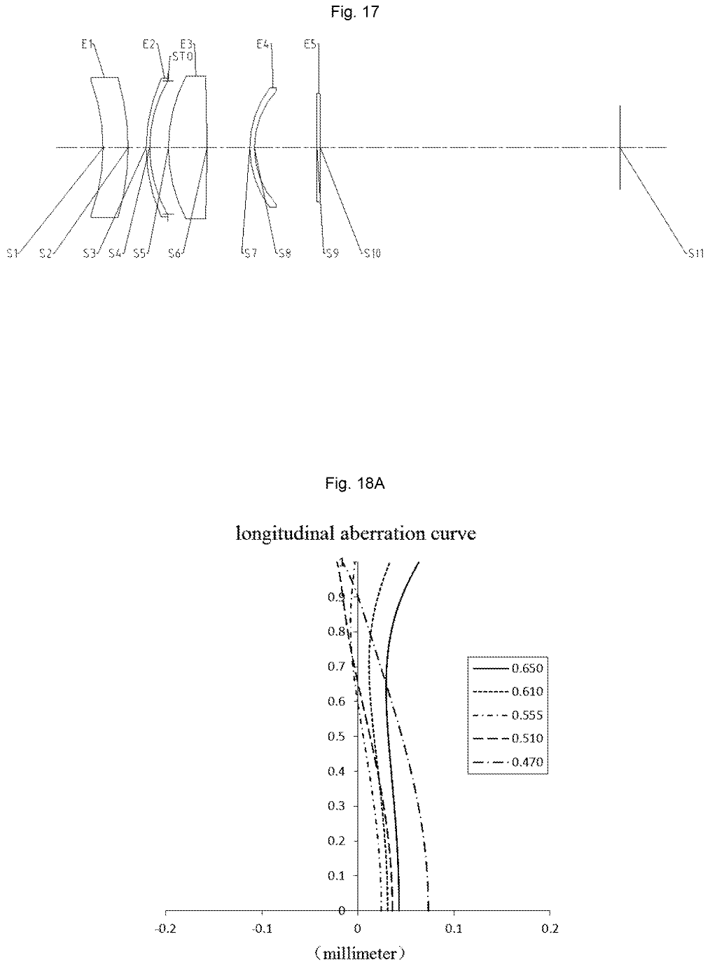

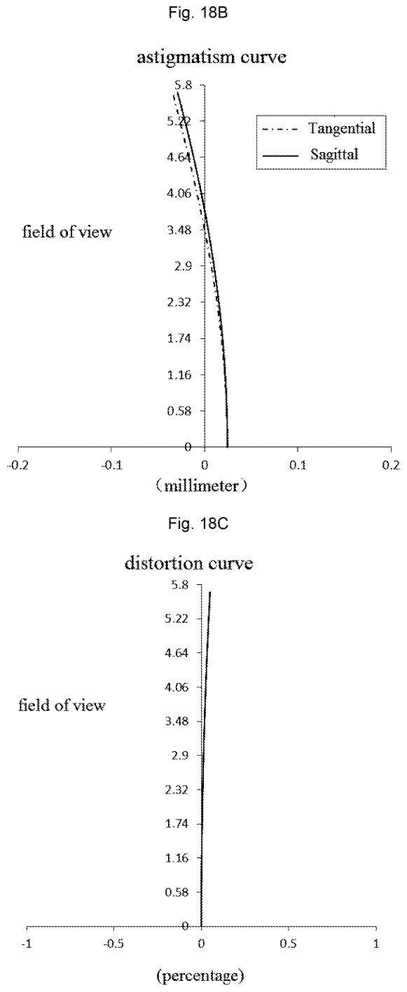

An optical imaging lens assembly according to embodiment 9 of the disclosure is described below with reference to FIG. 17 to FIG. 18C. FIG. 17 shows a structure diagram of an optical imaging lens assembly according to embodiment 9 of the disclosure.

As shown in FIG. 17, the optical imaging lens assembly sequentially includes the followings from an object side to an image side: a first lens E1, a second lens E2, a diaphragm STO, a third lens E3, a fourth lens E4, an optical filter E5, and an imaging surface S11.

The first lens E1 has a negative refractive power, wherein an object-side surface S1 thereof is a concave surface, and an image-side surface S2 thereof is a convex surface. The second lens E2 has a negative refractive power, wherein an object-side surface S3 thereof is a convex surface, and an image-side surface S4 thereof is a concave surface. The third lens E3 has a positive refractive power, wherein an object-side surface S5 thereof is a convex surface, and an image-side surface S6 thereof is a convex surface. The fourth lens E4 has a negative refractive power, wherein an object-side surface S7 thereof is a convex surface, and an image-side surface S8 thereof is a concave surface. The optical filter E5 has an object-side surface S9 and an image-side surface S10. Light from an object passes through the respective surfaces S1 to S10 in sequence and is finally imaged on the imaging surface S11.

In this example, the total effective focal length f of the optical imaging lens assembly is 27.00 mm; TTL is the total length of the optical imaging lens assembly, and TTL is 33.32 mm; ImgH is a half of the diagonal length of the effective pixel region on the imaging surface S11 of the optical imaging lens assembly, and ImgH is 2.71 mm; and FOV is the maximum field of view of the optical imaging lens assembly, and FOV is 11.47°.

Table 9 shows basic parameters of the optical imaging lens assembly according to embodiment 9. The units of curvature radius, thickness/distance, focal length, and effective radius are millimeters (mm).

TABLE 9

| Surface | Surface | Curvature | Thickness/ | | Refractive | Abbe | Focal | Effective |
|---|---|---|---|---|---|---|---|---|
| number | type | radius | distance | Material | index | number | length | radius |
| OBJ | Spherical | Infinity | Infinity | | | | | |
| S1 | Spherical | −12.2879 | 1.6065 | Glass | 2.01 | 29.1 | −72.53 | 4.2915 |
| S2 | Spherical | −15.7419 | 1.1635 | | | | | 4.5294 |
| S3 | Spherical | 10.7037 | 0.2250 | Glass | 2.01 | 29.1 | −45.38 | 4.4593 |
| S4 | Spherical | 8.5812 | 1.1906 | | | | | 4.3545 |
| STO | Spherical | Infinity | 0.0250 | | | | | 4.2889 |
| S5 | Spherical | 9.9390 | 2.4958 | Glass | 1.76 | 52.3 | 12.12 | 4.6182 |
| S6 | Spherical | −107.6650 | 2.7429 | | | | | 4.5271 |
| S7 | Spherical | 6.4083 | 0.2993 | Glass | 1.93 | 20.9 | −46.88 | 3.8628 |
| S8 | Spherical | 5.4619 | 4.0382 | | | | | 3.6816 |
| S9 | Spherical | Infinity | 0.2100 | Glass | 1.52 | 64.2 | | 3.5000 |
| S10 | Spherical | Infinity | 19.3267 | | | | | 3.5000 |
| S11 | Spherical | Infinity | | | | | | 2.7249 |

FIG. 18A shows a longitudinal aberration curve of the optical imaging lens assembly according to embodiment 9 to represent deviations of a convergence focal point after light with different wavelengths passes through the lens. FIG. 18B shows an astigmatic curve of the optical imaging lens assembly according to embodiment 9 to represent a tangential image surface curvature and a sagittal image surface curvature. FIG. 18C shows a distortion curve of the optical imaging lens assembly according to embodiment 9 to represent distortion values corresponding to different fields of views. As we can see from FIGS. 18A to 18C, the optical imaging lens assembly according to embodiment 9 can achieve high imaging quality.

To sum up, embodiments 1 to 9 respectively satisfy the relationships shown in Table 10.

TABLE 10

| Conditional expression\embodiment | 1 | 2 | 3 | 4 | 5 | 6 | 7 | 8 | 9 |
|---|---|---|---|---|---|---|---|---|---|
| f (mm) | 27.50 | 27.50 | 28.00 | 22.48 | 21.25 | 24.00 | 29.75 | 25.14 | 27.00 |
| (R7 − R8)/f4 | −0.64 | −0.10 | −0.43 | −0.20 | −0.10 | −1.69 | −0.03 | −0.02 | −0.02 |
| FOV (°) | 11.23 | 11.24 | 11.02 | 13.76 | 14.56 | 12.93 | 10.42 | 12.26 | 11.47 |
| f3/(DT31 + DT32) | 2.28 | 1.76 | 2.20 | 2.05 | 1.88 | 2.12 | 1.53 | 1.24 | 1.33 |
| DT11/DT41 | 1.18 | 1.16 | 1.17 | 1.06 | 1.07 | 0.97 | 1.12 | 1.13 | 1.11 |
| (N1 + N2 + N3 + N4)/4 | 1.93 | 1.93 | 1.93 | 1.93 | 1.93 | 1.93 | 1.93 | 1.93 | 1.93 |
| (CT1 + CT2)/(TTL − SL) | 0.69 | 0.57 | 0.74 | 0.81 | 0.79 | 0.62 | 0.13 | 0.20 | 0.44 |
| BFL/f | 0.78 | 0.83 | 0.78 | 0.96 | 0.96 | 1.11 | 0.85 | 0.76 | 0.87 |
| (SAG41 + SAG42)/ImgH | 0.60 | 0.70 | 0.78 | 0.66 | 0.62 | 0.47 | 1.50 | 0.99 | 1.00 |
| \|SAG11\|/(CT1 + T12) | 0.46 | 0.49 | 0.29 | 0.18 | 0.35 | 0.15 | 0.72 | 0.50 | 0.28 |

The disclosure also provides an imaging device. Its electronic photosensitive element may be a charge coupled device (CCD) or a complementary metal-oxide semiconductor (CMOS). The imaging device may be an independent imaging device such as a digital camera or an imaging module integrated on a mobile electronic device such as a mobile phone. The imaging device is equipped with an optical imaging lens assembly described above.

The preferred embodiments and technical principles of the disclosure are described herein. Those skilled in the art will understand that the scope of invention referred to in the disclosure is not limited to technical solutions formed by specific combinations of the above technical features, but also should cover other technical solutions formed by arbitrary combinations of the above technical features or their equivalent features without departing from the inventive concept, for example, the technical solutions formed by replacing the above features with (but not limited to) the technical features with similar functions disclosed in the disclosure.

What is claimed is:

1. An optical imaging lens assembly, sequentially comprising from an object side to an image side along an optical axis:
a first lens with a refractive power;
a second lens with a refractive power;
a third lens with a positive refractive power;
a fourth lens with a negative refractive power, wherein an object-side surface thereof is a convex surface; and
a total effective focal length f of the optical imaging lens assembly meets: 20 mm<f<30 mm.

2. The optical imaging lens assembly according to claim 1, wherein a curvature radius R7 of the object-side surface of the fourth lens, a curvature radius R8 of an image-side surface of the fourth lens, and an effective focal length f4 of the fourth lens meet: −1.7<(R7−R8)/f4<0.

3. The optical imaging lens assembly according to claim 1, wherein an effective focal length f3 of the third lens, an effective radius DT31 of an object-side surface of the third lens, and an effective radius DT32 of an image-side surface of the third lens meet: 1.2<f3/(DT31+DT32)<2.3.

4. The optical imaging lens assembly according to claim 1, wherein an effective radius DT11 of an object-side surface of the first lens and an effective radius DT41 of the object-side surface of the fourth lens meet: 0.8<DT11/DT41<1.2.

5. The optical imaging lens assembly according to claim 1, wherein a refractive index N1 of the first lens, a refractive index N2 of the second lens, a refractive index N3 of the third lens, and a refractive index N4 of the fourth lens meet: 1.8<(N1+N2+N3+N4)/4<2.0.

6. The optical imaging lens assembly according to claim 1, wherein the optical imaging lens assembly further comprises a diaphragm, and TTL is a distance from an object-side surface of the first lens to an imaging surface of the optical imaging lens assembly on the optical axis, and SL is a distance from the diaphragm to the imaging surface on the optical axis, a center thickness CT1 of the first lens on the optical axis, a center thickness CT2 of the second lens on the optical axis, TTL and SL meet: 0.1<(CT1+CT2)/(TTL−SL)<0.9.

7. The optical imaging lens assembly according to claim 1, wherein BFL is a distance from an image-side surface of the fourth lens to the imaging surface of the optical imaging lens assembly on the optical axis, BFL and the total effective focal length f of the optical imaging lens assembly meet: 0.7<BFL/f<1.2.

8. The optical imaging lens assembly according to claim 1, wherein SAG41 is a distance on the optical axis from an intersection point of the object-side surface of the fourth lens and the optical axis to an effective radius vertex of the object-side surface of the fourth lens, SAG42 is a distance on the optical axis from an intersection point of an image-side surface of the fourth lens and the optical axis to an effective radius vertex of the image-side surface of the fourth lens, and ImgH is a half of a diagonal length of an effective pixel region on the imaging surface of the optical imaging lens assembly, SAG41 and SAG42 and ImgH meet: 0.4<(SAG41+SAG42)/ImgH<1.6.

9. The optical imaging lens assembly according to claim 1, wherein SAG11 is a distance on the optical axis from an intersection point of an object-side surface of the first lens and the optical axis to an effective radius vertex of the object-side surface of the first lens, and T12 is a spacing distance between the first lens and the second lens on the optical axis, a center thickness CT1 of the first lens on the optical axis and SAG11 and T12 meet: 0.1<|SAG11|/(CT1+T12)<0.8.

10. The optical imaging lens assembly according to claim 1, wherein at least three lenses of the first lens to the fourth lens are made of a glass material.

11. The optical imaging lens assembly according to claim 1, wherein an object-side surface and an image-side surface of at least one of the first lens to the fourth lens are spherical surfaces.

12. The optical imaging lens assembly according to claim 1, wherein FOV is a maximum field of view of the optical imaging lens assembly, and FOV meets: 10°<FOV<15°.

13. The optical imaging lens assembly according to claim 2, wherein at least three lenses of the first lens to the fourth lens are made of a glass material.

14. The optical imaging lens assembly according to claim 2, wherein an object-side surface and an image-side surface of at least one of the first lens to the fourth lens are spherical surfaces.

15. The optical imaging lens assembly according to claim 2, wherein FOV is a maximum field of view of the optical imaging lens assembly, and FOV meets: 10°<FOV<15°.

16. The optical imaging lens assembly according to claim 3, wherein at least three lenses of the first lens to the fourth lens are made of a glass material.

17. The optical imaging lens assembly according to claim 3, wherein an object-side surface and an image-side surface of at least one of the first lens to the fourth lens are spherical surfaces.

18. The optical imaging lens assembly according to claim 3, wherein FOV is a maximum field of view of the optical imaging lens assembly, and FOV meets: 10°<FOV<15°.

19. The optical imaging lens assembly according to claim 4, wherein at least three lenses of the first lens to the fourth lens are made of a glass material.

20. The optical imaging lens assembly according to claim 4, wherein an object-side surface and an image-side surface of at least one of the first lens to the fourth lens are spherical surfaces.
